(19) United States
(12) Patent Application Publication
(10) Pub. No.: US 2004/0075338 A1
(43) Pub. Date: Apr. 22, 2004

(54) Hydraulic brake system and method for influencing a hydraulic brake system

(76) Inventors: Johannes Schmitt, Markgroeningen (DE); Rolf Gawlik, Beilstein (DE)

Correspondence Address: KENYON & KENYON, ONE BROADWAY, NEW YORK, NY, 10004, US

(21) Appl. No.: 10/415,217

(22) PCT Filed: Aug. 16, 2002
(86) PCT No.: PCT/DE02/03373

(30) Foreign Application Priority Data
Aug. 24, 2001 (DE) 101 41 606.7

(51) Int. Cl. B60T 8/34

(52) U.S. Cl. 303/113.1

(57) ABSTRACT

A hydraulic braking system is described having a brake master cylinder (10), at least two brake circuits (30, 32) which are hydraulically connected to the brake master cylinder (10), solenoid valves (58, 60, 62, 64, 66, 68, 70, 72, 74, 76, 78, 80) which are individually assigned to the brake circuits (30, 32), and means for supplying voltage pulses to the solenoid valves (58, 60, 62, 64, 66, 68, 70, 72, 74, 76, 78, 80), through which the hydraulic pressure in the brake circuits (30, 32) may be modulated, the solenoid valves (58, 60, 62, 64, 66, 68, 70, 72, 74, 76, 78, 80) able to be supplied with activations which are individual for each wheel or specific to each brake circuit. Furthermore, a method of influencing a hydraulic braking system having a brake master cylinder and at least two brake circuits is described.

The present invention relates to a hydraulic braking system having a brake master cylinder, at least two brake circuits which are hydraulically connected to the brake master cylinder, solenoid valves which are individually assigned to the brake circuits, and means for supplying voltage pulses to the solenoid valves, through which the hydraulic pressure in the brake circuits is modulated. Furthermore, the present invention relates to a method of influencing a hydraulic braking system having a brake master cylinder, at least two brake circuits which are hydraulically connected to the brake master cylinder, and solenoid valves which are individually assigned to the brake circuits, voltage pulses being supplied to the solenoid valves, through which the hydraulic pressure in the brake circuits is modulated.

### BACKGROUND INFORMATION

In most cases, hydraulic braking systems are equipped with two brake circuits which are separate from one another. A braking pressure may be built up in both brake circuits using a brake master cylinder, specifically in that a tandem master cylinder is used, which implements a rod circuit and a floating circuit in combination with the brake circuits. A pressure is built up in the rod circuit in that a primary piston assembly is displaced directly by a rod, which is in turn moved by a brake pedal. Hydraulic fluid is taken from a reservoir and is thus available for the pressure buildup in the rod circuit. A further piston is operated through the operation of the brake pedal. This piston also compresses hydraulic fluid taken from a reservoir and thus provides pressure in a floating circuit.

In particular during pressure buildup in the case of a traction control system (TCS) or an electronic stability program (ESP), differences in the pressure buildup in the two brake circuits may occur due to strongly differing flow speeds (caused by different flow resistances, for example) in the rod circuit or the floating circuit of the brake master cylinder. The large flow differences may, for example, be produced by tolerances in components or tolerances in their positioning, these tolerances having effects which are further amplified at low temperatures in particular.

Identical effects are observed if the brake lines are of different lengths, have different diameters, have different numbers of joints, or the flow coefficients of the lines to the individual wheels within the hydraulic modulator are different. Even within the hydraulic modulator, the differences cited (differing lengths of the brake lines, the diameter, differing numbers of joints, or differing bore dimensions) may arise.

If, for example, one wishes to drive in winter on a slippery roadway, the differences in the pressure buildup may lead to the traction control system not being capable of stabilizing the road handling. While the braking pressure is already sufficiently large at one drive wheel to perform a braking intervention as part of a traction control regulation, the pressure in the other brake circuit may possibly not yet be sufficient to allow such a braking intervention. The consequence is one spinning drive wheel and one non-spinning drive wheel, so that the vehicle tends with some probability to drift.

### ADVANTAGES OF THE INVENTION

The present invention builds on the hydraulic braking system according to the definition of the species in the main claim in that the solenoid valves may be supplied with activations which are specific to the braking circuits. The activations may differ in regard to the activation times and may be designed as pulse sequences which are individual for each wheel or, in particular, specific to each brake circuit. In this way, the wheels or the brake circuits may be influenced individually, so that differences in the two brake circuits may be compensated for, i.e., there are individual activations for each wheel or specific activations for each brake circuit. In this case, the characteristic of the pulse sequences may advantageously be determined by the pulse-pause ratio.

The hydraulic braking system is advantageously refined in that the effects of flow differences during a pressure buildup in a rod brake circuit and a floating brake circuit may be compensated for through the two different pulse sequences. In particular for pressure buildup during a traction control regulation, the flow differences in the rod circuit and the floating circuit have especially strong effects. In this case, the supply of different pulse sequences specific to each brake circuit may be especially advantageous.

The hydraulic braking system (and/or the method according to the present invention and the device according to the present invention) is advantageous in particular in the case in which it has an X brake circuit distribution, one of the wheels of a drive axle being assigned to the rod circuit and the other wheel of the drive axle being assigned to the floating circuit. For an X brake circuit distribution in the case of a front wheel drive used as an example, the left front wheel is assigned to the rod circuit and the right front wheel is assigned to the floating circuit, for example. Because the two brake circuits are now modulated using different pulse sequences, both drive wheels may have an equally rapid pressure buildup and thus implement the requirements for a stable traction control regulation.

The hydraulic braking system (and/or the method according to the present invention and the device according to the present invention) may, however, also be useful if it has a II braking force distribution. Since motor vehicles have greatly differing drive systems, it may be useful if the present invention is implemented for all current braking force distribution patterns.

In an advantageous embodiment, the hydraulic braking system is distinguished in that the activations are configured so that they may compensate for differences of the braking effect of the individual wheels or brake circuits caused by the braking system.

The present invention builds on the method of influencing a hydraulic braking system according to the definition of the species in the main claim in that the solenoid valves may be supplied with activations or pulse sequences which are individual for each wheel or specific to each brake circuit. In this way, the advantages of the system according to the present invention are also implemented in the scope of a method.

The method of influencing a hydraulic braking system is advantageously refined in that the effects of flow differences during a pressure buildup in a rod brake circuit and a floating brake circuit are compensated for by the pulse sequences.

The method of influencing a hydraulic braking system is especially advantageous in the case in which it is used for an X brake circuit distribution, one of the wheels of a drive axle being assigned to the rod circuit and the other wheel of the drive axle being assigned to the floating circuit.

The method of influencing a hydraulic braking system may, however, also be useful if it is used with a II braking force distribution.

Furthermore, the method may be designed so that the effects of flow differences are taken into consideration in a hydraulic pressure model and flow differences of the two braking circuits are compensated for in this way.

In an advantageous embodiment, the method is distinguished in that the activations are configured so that they may compensate for differences of the braking effect of the individual wheels or brake circuits caused by the braking system.

The present invention is based on the surprising recognition that by providing two pulse sequences, which are generally different, it is possible to compensate for differences in the pressure buildup caused by the braking system (for example, the brake master cylinder). In this way, equally rapid TCS pressure buildup or ESP pressure buildup (ESP=“electronic stability program”) may be provided for all wheels, so that in the end stable road handling is achieved.

### DRAWING

The present invention will now be explained in relation to the attached drawing on the basis of a preferred exemplary embodiment.

FIG. 1 shows a hydraulic system having an X braking force distribution, in which the present invention may be implemented.

FIG. 2 shows a further hydraulic system for ABS, TCS, or ESP systems having an X braking force distribution, in which the present invention may also be implemented.

### DESCRIPTION OF THE EXEMPLARY EMBODIMENT

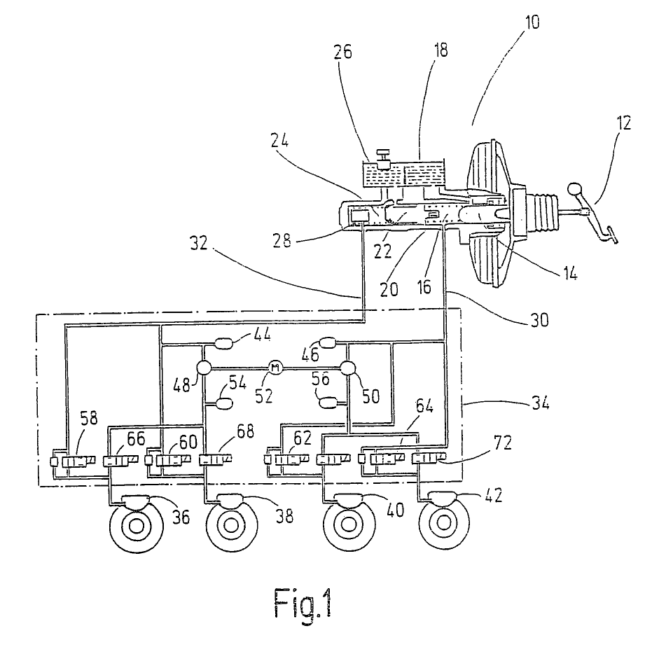

FIG. 1 shows a schematic illustration of a hydraulic system having an X braking force distribution, in which the present invention may be implemented. A brake master cylinder 10 is illustrated. A brake pedal 12 is connected to a first cylinder chamber 16 via a primary piston assembly 14. First cylinder chamber 16 communicates with a hydraulic reservoir 18. Furthermore, primary piston assembly 14 is connected via a compression spring 20 to an intermediate piston 22. Intermediate piston 22 is capable of compressing a hydraulic fluid in a second cylinder chamber 24. This cylinder chamber 24 also communicates with a hydraulic reservoir 26. Intermediate piston 22 is supported by a further compression spring 28, which is positioned in second cylinder chamber 24. First cylinder chamber 16 is connected to a rod circuit 30. Second cylinder chamber 24 is connected to a floating circuit 32. Both rod circuit 30 and floating circuit 32 are connected to a hydraulic modulator 34. Brake cylinder 36 of the left rear wheel, brake cylinder 38 of the right front wheel, brake cylinder 40 of the left front wheel, and brake cylinder 42 of the right rear wheel are hydraulically activated via hydraulic modulator 34. The associated brake disks are illustrated next to wheel brake cylinders 36, 38, 40, and 42. Damper chambers 44, 46, return pumps 48, 50, a motor 52, accumulators 54, 56, intake valves 58, 60, 62, 64, and outlet valves 66, 68, 70, and 72 are provided in the hydraulic modulator. Hydraulic modulator 34 is designed so that the floating circuit is assigned to wheel brake cylinder 36 for the left rear wheel and wheel brake cylinder 38 for the right front wheel, while rod circuit 30 is assigned to wheel brake cylinder 40 of the left front wheel and wheel brake cylinder 42 of the right rear wheel. In this way, an X braking force distribution is implemented.

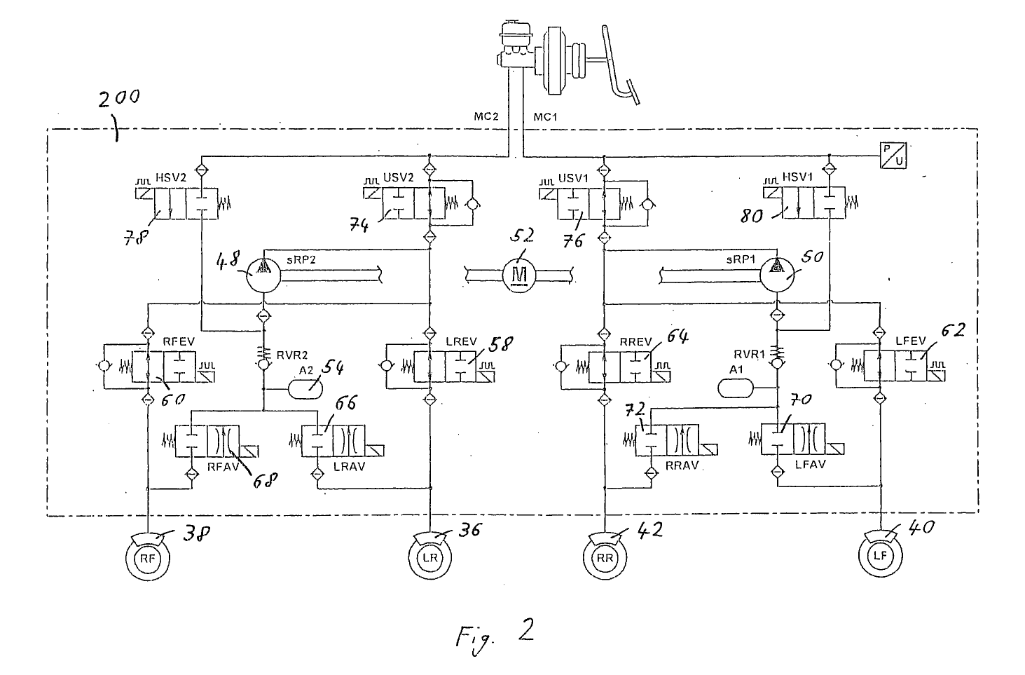

A further braking system (also having an X brake circuit distribution) is illustrated in FIG. 2. This braking system is used in numerous TCS and ESP systems. In this case, identical reference numbers are used in FIG. 2 for components identical to those in FIG. 1.

In this case, the left brake circuit is the floating circuit and the right brake circuit is the rod circuit. 200 indicates the hydraulic modulator. This braking system also has return pumps 48 and 50, intake valves 58, 60, 62, and 64, and outlet valves 66, 68, 70, and 72. In contrast to FIG. 1, this brake circuit also has switching valves 74 and 76 and high-pressure switching valves 78 and 80. Hydraulic modulator 200 is designed so that the floating circuit is assigned to wheel brake cylinder 36 for the left rear wheel and wheel brake cylinder 38 for the right front wheel, while the rod circuit is assigned to wheel brake cylinder 40 of the left front wheel and wheel brake cylinder 42 of the right rear wheel. In this way, an X braking force distribution is implemented.

Individual activation for each wheel is to be achieved, for example, through individual activation of the intake and outlet valves for each wheel, and specific activation for each brake circuit is, for example, to be achieved through specific activation of the switching valves, the high-pressure switching valves, or the return pumps for each brake circuit.

If, for example, the front wheels are the drive wheels, the effects of differing pressure buildup in floating circuit 32 and/or in rod circuit 34 may be compensated for through different pulse sequences in floating circuit 32 and in rod circuit 34.

The description of the exemplary embodiments according to the present invention which is specified above and also in the claims is only used for illustrative purposes and not for the purpose of restricting the present invention. Various changes and modifications are possible within the framework of the present invention without leaving the scope of the present invention and its equivalents. In particular, the present invention is also suitable for use in the context of electrohydraulic braking systems (EHB).

What is claimed is:

1. A hydraulic braking system comprising
a brake master cylinder (10),
at least two brake circuits (30, 32) which are hydraulically connected to the brake master cylinder (10),
solenoid valves (58, 60, 62, 64, 66, 68, 70, 72, 74, 76, 78, 80) which are individually assigned to the brake circuits (30, 32), and
means for supplying voltage pulses to the solenoid valves (58, 60, 62, 64, 66, 68, 70, 72, 74, 76, 78, 80), thereby enabling the hydraulic pressure in the brake circuits (30, 32) to be modulated,
wherein the solenoid valves (58, 60, 62, 64, 66, 68, 70, 72, 74, 76, 78, 80) are able to receive activations which are individual for each wheel or specific to each brake circuit.

2. The hydraulic braking system as recited in claim 1, wherein the effects of flow differences during a pressure buildup in a rod brake circuit (30) and a floating brake circuit (32) can be compensated for by the activations.

3. The hydraulic braking system as recited in claim 1 or 2, wherein it has an X brake circuit distribution, one of the wheels (40) of a drive axle being assigned to the rod circuit (30) and the other wheel (38) of the drive axle being assigned to the floating circuit (32).

4. The hydraulic braking system as recited in one of the preceding claims, wherein the braking system has a II braking force distribution.

5. The hydraulic braking system as recited in claim 1, wherein the activations are configured so that they may compensate for differences of the braking effect of the individual wheels or brake circuits caused by the braking system.

6. A method of influencing a hydraulic braking system comprising
a brake master cylinder (10),
at least two brake circuits (30, 32) which are hydraulically connected to the brake master cylinder (10), and
solenoid valves (58, 60, 62, 64, 66, 68, 70, 72, 74, 76, 78, 80) which are individually assigned to the brake circuits (30, 32),
voltage pulses being supplied to the solenoid valves (58, 60, 62, 64, 66, 68, 70, 72, 74, 76, 78, 80), thereby modulating the hydraulic pressure in the brake circuits (30, 32),
wherein the solenoid valves (58, 60, 62, 64, 66, 68, 70, 72, 74, 76, 78, 80) receive activations which are individual for each wheel or specific to each brake circuit.

7. The method of influencing a hydraulic braking system as recited in claim 5, wherein the effects of flow differences during a pressure buildup in a rod brake circuit (30) and a floating brake circuit (32) are compensated for by the activations which are individual for each wheel or specific to each brake circuit.

8. The method of influencing a hydraulic braking system as recited in claim 5 or 6, wherein it is used in a braking system having an X brake circuit distribution, one of the wheels (40) of a drive axle being assigned to the rod circuit (30) and the other wheel (38) of the drive axle being assigned to the floating circuit (32).

9. The method of influencing a hydraulic braking system as recited in one of claims 5 through 7, wherein it is used in a braking system having a II braking force distribution.

10. The method of influencing a hydraulic braking system as recited in one of claims 5 through 8, wherein an individual compensation for each wheel is performed in connection with an electronic stability program.

11. The method of influencing a hydraulic braking system as recited in one of claims 5 through 9, wherein flow differences are taken into consideration and compensated for in a hydraulic pressure model.

12. The method of influencing a hydraulic braking system as recited in claim 6, wherein the activations are configured so that they may compensate for differences of the braking effect of the individual wheels or brake circuits caused by the braking system.
